(19) United States
(12) Patent Application Publication
(10) Pub. No.: US 2019/0228664 A1
(43) Pub. Date: Jul. 25, 2019

(54) VEHICLE CALLING SYSTEM

(71) Applicant: SUBARU CORPORATION, Tokyo (JP)

(72) Inventor: Junya SEKI, Tokyo (JP)

(21) Appl. No.: 16/172,443

(22) Filed: Oct. 26, 2018

(30) Foreign Application Priority Data
Jan. 22, 2018 (JP) 2018-008248

(51) Int. Cl. G08G 1/00; G05D 1/00; B60W 30/06; G01C 21/34; G06K 9/00

(52) U.S. Cl. CPC G08G 1/202; G05D 1/0088; B60W 30/06; G05D 2201/0213; G06K 9/00791; G05D 1/0038; G01C 21/3453

(57) ABSTRACT

A vehicle calling system includes a vehicle, a user terminal, and a parking-area management system. The vehicle can travel autonomously from a parking area to a boarding location. The user terminal transmits a call for the vehicle by being operated by a user. The parking-area management system receives the call and causes the vehicle to travel from the parking area. The parking-area management system includes a boarding-location-option extracting unit and a vehicle-travel commanding unit. The boarding-location-option extracting unit extracts boarding location options convenient for the user from a plurality of the boarding locations and transmits the options to the user terminal in response to the call. When a designated boarding location selected and designated by the user from the options is received from the user terminal, the vehicle-travel commanding unit transmits a command to the vehicle to cause the vehicle to travel to the designated boarding location.

### CROSS-REFERENCE TO RELATED APPLICATIONS

The present application claims priority from Japanese Patent Application No. 2018-008248 filed on Jan. 22, 2018, the entire contents of which are hereby incorporated by reference.

### BACKGROUND

### 1. Technical Field

The present invention relates to vehicle calling systems that call vehicles capable of traveling autonomously from parking areas to boarding locations.

### 2. Related Art

In recent years, there has been proposed a system that causes a vehicle having an autonomous traveling function to travel autonomously to park in a parking area, and that also calls the vehicle parked in the parking area to travel autonomously to a designated boarding location.

For instance, Japanese Patent No. 6179432 discloses a vehicle management system in which, if a user's automobile cannot reach a boarding location by a scheduled departure time designated by the user, the vehicle management system can adjust the scheduled departure time with the user. In the vehicle management system according to Japanese Patent No. 6179432, if the current position of the user is closer to other boarding locations than to the designated boarding location at a predetermined time prior to the scheduled departure time, a boarding location closest to the current position of the user is proposed to the user so that the boarding location can be adjusted with the user.

### SUMMARY OF THE INVENTION

A vehicle calling system according to an aspect of the present invention includes a vehicle, a user terminal, and a parking-area management system. The vehicle is capable of travelling autonomously from a parking area to a boarding location. The user terminal is configured to transmit a call for the vehicle by being operated by a user. The parking-area management system is configured to receive the call for the vehicle from the user terminal and to cause the vehicle to travel from the parking area. The parking-area management system includes a boarding-location-option extracting unit and a vehicle-travel commanding unit. The boarding-location-option extracting unit is configured to extract boarding location options convenient for the user from a plurality of the boarding locations and to transmit the boarding location options to the user terminal in response to the call for the vehicle from the user terminal. The vehicle-travel commanding unit is configured such that, when a designated boarding location selected and designated by the user from the boarding location options is received from the user terminal, the vehicle-travel commanding unit transmits a command to the vehicle to cause the vehicle to travel to the designated boarding location.

### BRIEF DESCRIPTION OF THE DRAWINGS

FIG. 1 illustrates the overall configuration of a vehicle calling system;

FIG. 2 illustrates travel routes for a user and a vehicle toward a boarding location; and

FIG. 3 is a flowchart illustrating a procedure of a vehicle calling process.

### DETAILED DESCRIPTION

Hereinafter, an example of the present invention will be described with reference to the drawings. Note that the following description is directed to an illustrative example of the present invention and not to be construed as limiting to the present invention. Factors including, without limitation, numerical values, shapes, materials, components, positions of the components, and how the components are coupled to each other are illustrative only and not to be construed as limiting to the present invention. Further, elements in the following example which are not recited in a most-generic independent claim of the present invention are optional and may be provided on an as-needed basis. The drawings are schematic and are not intended to be drawn to scale. Throughout the present specification and the drawings, elements having substantially the same function and configuration are denoted with the same reference numerals to avoid any redundant description. The vehicle management system disclosed in Japanese Patent No. 6179432 simply presents a closer location than the location designated by the user but does not take into consideration the ease of travel using an elevator and an escalator and the travel time according to the walking distance when the user travels to the boarding location. Thus, it is difficult for the user to select a boarding location that is convenient for the user.

It is desirable to provide a vehicle calling system that allows a user to select a highly-convenient boarding location from a plurality of boarding locations when calling a vehicle from a parking area.

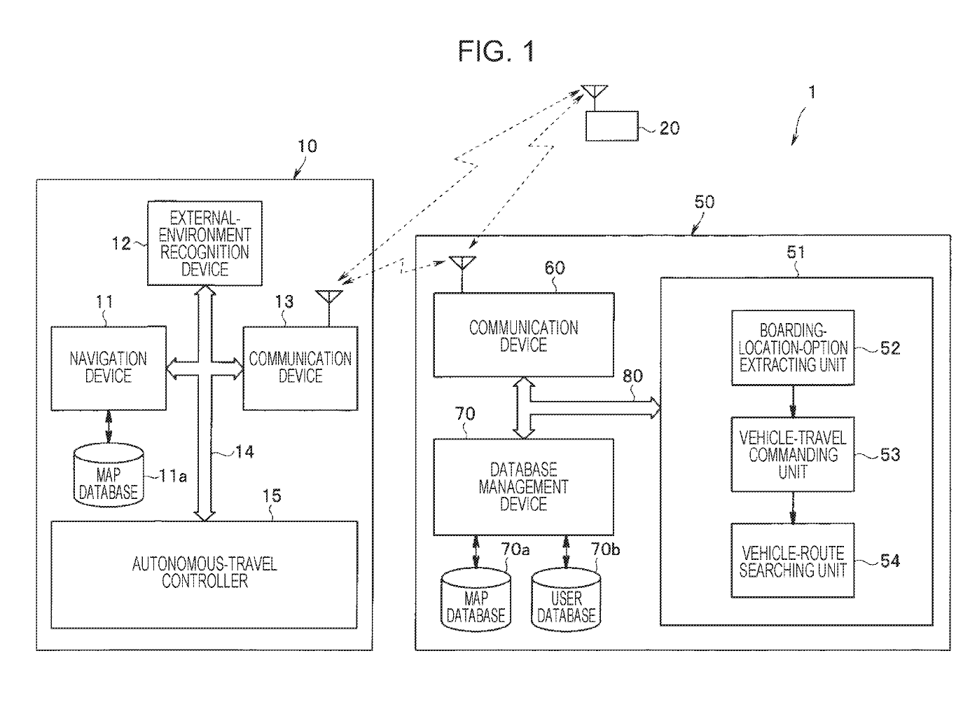

A vehicle calling system 1 illustrated in FIG. 1 provides a service to a user visiting, for instance, a large-scale complex having a plurality of commercial stores and venues, such that the service causes a user's vehicle parked in a parking area in the complex to travel autonomously to a predetermined boarding location in response to a user's request.

In this example, the vehicle calling system 1 includes a vehicle 10 having an autonomous traveling function that allows the vehicle 10 to travel autonomously from a parking area to a boarding location where a user boards the vehicle 10, a portable user terminal 20 owned by the user, and a parking-area management system 50 that manages a plurality vehicles parked in the parking area. The vehicle 10, the user terminal 20, and the parking-area management system 50 are capable of exchanging data with one another by wireless communication.

The vehicle 10 includes an autonomous-travel controller that enables autonomous traveling by controlling the driving of a power source, such as an engine and/or an electric motor. The autonomous-travel controller 15 is mainly constituted of a micro-computer and is coupled to other devices, such as a navigation device 11, an external-environment recognition device 12, and a communication device 13, via a communication bus 14 that constitutes an in-vehicle network.

The navigation device 11 includes a map database 11a, and measures the position of the vehicle 10 based on signals from a plurality of navigation satellites, such as global positioning system (GPS) satellites, and signals from in-vehicle sensors (such as a gyroscope sensor and a vehicle-speed sensor) and checks the measured position with the map database 11a. Then, the navigation device 11 presents routing assistance and traffic information to the driver by displaying them on a display device (not illustrated) based on the positional information on the map and traffic information acquired by infrastructure communication, such as road-to-vehicle communication and vehicle-to-vehicle communication.

Furthermore, the navigation device 11 generates routing assistance information to a destination from service-area map information received from the parking-area management system 50. The destination in this case is an unoccupied parking space in a parking area if the vehicle 10 is to stop at a drop-off location in a complex and then to travel autonomously to the parking area, or is an unoccupied stopping space of a boarding location if the vehicle 10 is to travel from the parking area to a boarding location.

The external-environment recognition device 12 includes various types of sensors such as a camera and a radar device that detect objects surrounding the vehicle 10, and recognizes the external environment surrounding the vehicle 10 based on detection information from these sensors and the map information and the traffic information from the navigation device 11. The recognition information about the external environment surrounding the vehicle 10 obtained by the external-environment recognition device 12 is transmitted to the autonomous-travel controller 15 and is used as control data for steering control for autonomous travel along a route, as well as braking control for preventing a collision with an obstacle.

The communication device 13 exchanges data with the parking-area management system 50 by communicating therewith using a predetermined wireless communication method. The exchanging of data with the parking-area management system 50 based on wireless communication is executed by using either one of a local area network established in the service area of the parking-area management system 50 and a general-purpose network, such as the Internet, while required security is ensured.

The communication device 13 may be a dedicated device or may be used in a dual-purpose fashion as a communication device of the navigation device 11.

In this example, the autonomous-travel controller 15 communicates with the user terminal 20 and the parking-area management system 50 via the communication device 13, causes the vehicle 10 to travel autonomously from a drop-off location of the user to a parking area, and causes the vehicle 10 to stop and wait at a predetermined parking position. Then, when the autonomous-travel controller 15 receives a travel command from the parking-area management system 50, the autonomous-travel controller 15 causes the vehicle 10 to travel autonomously to a designated boarding location.

Specifically, the autonomous-travel controller 15 causes the vehicle 10 to travel autonomously to the destination in accordance with the routing assistance information generated by the navigation device 11 based on the map information from the parking-area management system 50. Moreover, if an obstacle is detected by the external-environment recognition device 12 during the travel to the destination, the autonomous-travel controller 15 executes either one of steering control and braking control to avoid a collision. Furthermore, when the vehicle 10 approaches the parking space, the autonomous-travel controller 15 transmits information about the surrounding environment via the communication device 13 so as to provide a notification to the user.

The autonomous traveling function of the vehicle 10 may at least include an autonomous traveling function that allows the vehicle 10 to travel unmanned to the boarding location from the parking area located in the service area of the parking-area management system 50.

The user terminal 20 is a portable terminal owned by the user using the vehicle 10 and is constituted of either one of a dedicated terminal having a wireless communication function and a general-purpose terminal. If a general-purpose terminal is used, for instance, any one of a portable telephone, such as a smartphone, a tablet terminal having a wireless communication function, and a notebook personal computer having a wireless communication function may be used and may have a dedicated application installed therein, thereby achieving a required function.

The user terminal 20 is registered together with the vehicle 10 in the parking-area management system 50 at the time of the first visit to the service area of the parking-area management system 50 or as a membership service. Under authentication from the parking-area management system 50, the parking-area management system 50, the user terminal 20, and the vehicle 10 communicate with one another.

The parking-area management system 50 includes a central controller 51, and also includes a communication device 60 and a database management device 70 that are coupled to the central controller 51. The central controller 51 is the central device of the parking-area management system 50, is constituted of one or more computer systems, and is coupled to the communication device 60 and the database management device 70 via a system bus 80.

The communication device 60 performs registration and authentication of the vehicle 10 and the user terminal 20 of the visiting user and exchanges data with the user terminal and the communication device 13 of the vehicle 10 via either one of a network established in the service area of the parking-area management system 50 and a general-purpose network, such as the Internet. The communication device 60 is coupled to a plurality of sub stations set in the service area.

The database management device 70 has a map database 70a storing detailed map information of the service area of the parking-area management system 50, and also has a user database 70b storing management information about the user and vehicle visiting the service area. The map database 70a and the user database 70b are associated with each other, are referred to by the central controller 51 via the database management device 70, and are updated as needed by the database management device 70.

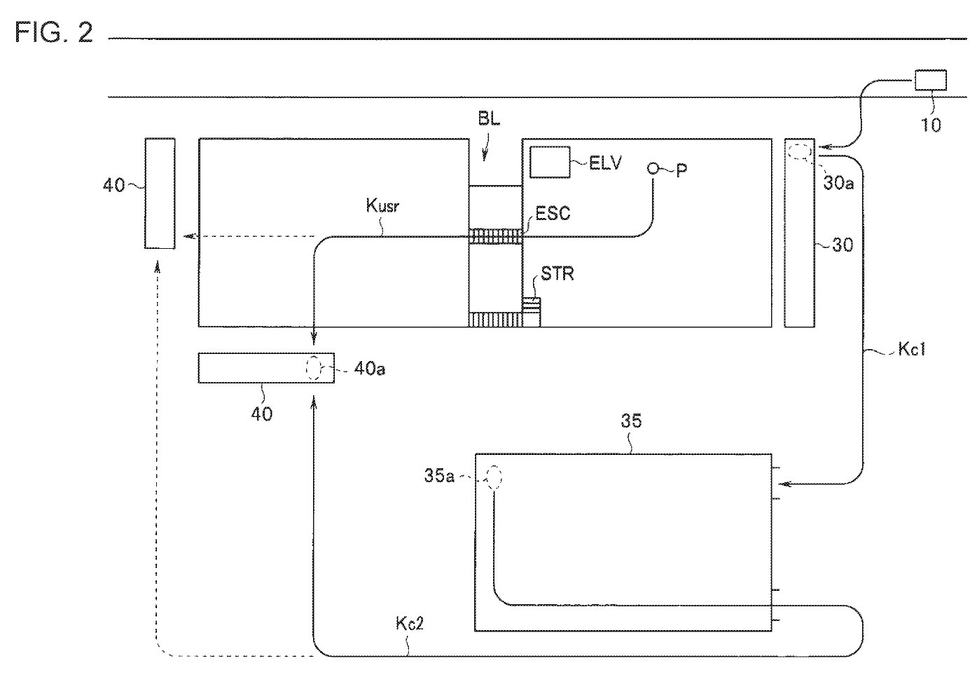

As illustrated in FIG. 2, the map database 70a contains map information of a drop-off location 30 where the user visiting a complex BL is dropped off from the vehicle 10, map information of a parking area 35 where the vehicle 10 is to be parked, map information of a plurality of boarding locations 40 where the user calling the vehicle 10 can board the vehicle 10, and positional information of commercial stores in the complex BL. The map information of the parking area 35 is linked with attribute information including parkable information indicating whether the vehicle 10 can be parked in the parking area 35, positional information of a parking space 35a where the vehicle 10 can be parked, and the number of vehicles that have entered and exited the parking area 35 recorded together with the time of entry and exit. The map information of each boarding location 40 is also linked with attribute information including stoppable information indicating whether the vehicle 10 can stop and positional information of a stopping space 40a where the vehicle 10 can stop.

In addition to information about a travel route Kc1 of the vehicle 10 from the drop-off location 30 to the parking area 35 and information about a travel route Kc2 of the vehicle 10 from the parking area 35 to each boarding location 40, traffic conditions, such as the number and the speed of vehicles traveling along each travel route, are also recorded together with the elapse of time in the map database 70a. Moreover, the map database 70a contains positional information of stairs STR, an escalator ESC, and an elevator ELV existing in the complex BL. As will be described later, the positional information is referred to when boarding location options convenient for the user are to be extracted from the plurality of boarding locations 40.

In the user database 70b, vehicle information used for identifying a vehicle, such as a registration number of the vehicle 10, user information, such as a registration ID and password of the user terminal 20, and information about user's mail address are stored in correspondence with one another. The user information has added thereto priority information given to high-spending shoppers, frequent shoppers, shoppers who have bought large and heavy items, people with disabilities, and elderlies. When a user uses, for instance, either one of a card issued by each store and a store-affiliated credit card, the purchase history of the user is acquired by a corresponding management server and is transmitted from the management server to the communication device 60.

When the central controller 51 receives, from the vehicle 10 arriving in a stopping space 30a at the drop-off location 30, information indicating that the vehicle 10 is unmanned and that the vehicle 10 can be parked, the central controller 51 refers to the map database 70a so as to search through the parking area 35 for the parking space 35a where the vehicle 10 can be parked. Then, the central controller sets the parking space 35a where the vehicle 10 can be parked as a destination, transmits an autonomous-travel start signal to the vehicle 10 from the communication device 60, and causes the vehicle 10 to travel autonomously from the stopping space 30a at the drop-off location 30 toward the parking space 35a in the parking area 35. Moreover, when the central controller 51 receives a parking completion signal from the vehicle 10, the central controller 51 updates the parkable information in the map database 70a so as to set the corresponding parking space to a non-parkable status.

Subsequently, for instance, if the user decides to return home and thus calls the vehicle 10 in the parking area 35 by operating the user terminal 20, the central controller 51 receives the call signal from the user terminal 20 via the communication device 60 and transmits a travel command to the vehicle 10. In this case, the central controller 51 presents boarding location options convenient for the user, causes the vehicle 10 to travel to the boarding location selected by the user, and presents a route to the corresponding boarding location to the user. As functional units related to this vehicle calling process, the central controller 51 includes a boarding-location-option extracting unit 52, a vehicle-travel commanding unit 53, and a vehicle-route searching unit 54. In response to the call signal received from the user via the user terminal 20, the boarding-location-option extracting unit 52 extracts boarding location options convenient for the user from the plurality of boarding locations 40 in accordance with predetermined criteria based on the parking position in the parking area 35 where the vehicle 10 is parked, the current position of the user, map information of neighboring facilities surrounding the user and the vehicle 10.

As described in criteria 1 to 4 below, in this example, the boarding location options are extracted based on conditions including the walking distance, time, level of ease, and vehicle energy consumption as the criteria for convenience.

1. Boarding Location at Short Walking Distance

For each of the plurality of boarding locations, the use of the stairs STR is permitted, and a walking distance of a route Kusr from a current position P of the user in the complex BL (i.e., in the service area of the parking-area management system 50) to the boarding location is calculated. Then, the boarding location located at the shortest walking distance and reachable with the shortest distance is extracted as a boarding location option to be presented to the user via the user terminal 20.

2. Boarding Location Allowing Quick Boarding

For each of the plurality of boarding locations, an expected arrival time at which the vehicle is expected to arrive is calculated from the distance between the parking position of the vehicle and the boarding location, and from the traffic condition at the boarding location. Moreover, an expected arrival time at which the user is expected to arrive at the boarding location by traveling from the current position is calculated.

For each boarding location, the expected arrival time for the vehicle and the expected arrival time for the user are compared, and the later time is set as a boardable time. The boarding location with the earliest boardable time from among the plurality of boarding locations is extracted as a boarding location option to be presented to the user.

3. Boarding Location Reachable with Ease

For each of the plurality of boarding locations, the use of the stairs STR is excluded, whereas the use of the elevator ELV and the escalator ESC is prioritized. Under such a condition, the boarding location that can be reached by a route with the shortest walking distance from the current position P of the user is extracted as a boarding location option to be presented to the user.

4. Vehicle Energy Consumption

For each of the plurality of boarding locations, the amount of energy, such as fuel and electric power, to be consumed by the vehicle 10 for traveling from the parking area 35 to the boarding location is estimated. The boarding location that can be reached with the lowest energy consumption by the vehicle 10 is extracted as a boarding location option to be presented to the user.

The boarding location options extracted based on criteria 1 to 4 described above are transmitted to the user terminal 20 via the communication device 60 such that the boarding location options are selectable by the user. For instance, a screen of the user terminal 20 displays the boarding location options together with the descriptions of criteria 1 to 4. When the user selects and designates a desired boarding location by tapping a corresponding region on the screen of the user terminal 20 or by performing a key input operation, the designated boarding location is transmitted from the user terminal 20 to the parking-area management system 50.

When the designated boarding location selected by the user from the boarding location options and transmitted from the user terminal 20 is received by the vehicle-travel commanding unit 53 via the communication device 60, the vehicle-travel commanding unit 53 searches for a route from the parking area 35 to the designated boarding location by referring to the map database 70a, and transmits a travel command to cause the vehicle 10 to travel autonomously along the route from the parking area 35 to the designated boarding location.

In this case, the vehicle-travel commanding unit 53 calculates an expected arrival time at which the vehicle 10 is expected to arrive at the designated boarding location, and transmits the expected arrival time to the user terminal 20. The expected arrival time at which the vehicle 10 is expected to arrival at the designated boarding location may be calculated by correcting, in view of a change of situation, the expected arrival time calculated when the boarding location options are extracted, or may be newly calculated based on the distance from the parking position of the vehicle to the boarding location and the traffic condition at the boarding location.

Furthermore, the vehicle-travel commanding unit 53 transmits information about the surrounding region of the designated boarding location to the user terminal 20 when the vehicle 10 approaches either one of the user and the designated boarding location. Accordingly, the user can easily ascertain the traffic condition at the designated boarding location and the detailed position of an unoccupied space where the vehicle 10 is to stop, thereby allowing for smooth boarding.

The information about the surrounding region of the designated boarding location includes vehicle-exterior-image information captured by a camera installed in the vehicle 10. The vehicle-travel commanding unit 53 commands the vehicle 10 to transmit the captured image to the user terminal 20. With regard to the timing at which the image information is transmitted from the vehicle 10, for instance, the movements of the vehicle 10 and the user are tracked by the parking-area management system 50, and the transmission command is given when either one of the distance between the vehicle 10 and the user and the distance between the vehicle 10 and the designated boarding location becomes a predetermined value or smaller.

The image information from the vehicle 10 may be transmitted while the progress of the vehicle 10 along the route to the boarding location is ascertained. Moreover, the image information transmitted to the user terminal 20 is not limited to a captured image of an actual external environment, and may be an image obtained by combining the map image of the surrounding region of the boarding location with an image indicating, for instance, the traffic conditions of other vehicles.

When the vehicle-route searching unit 54 receives the designated boarding location selected and designated by the user, the vehicle-route searching unit 54 searches through the map database 70a for the route Kusr along which the user travels to the designated boarding location, and transmits the route Kusr to the user terminal 20. In this case, depending on the designated boarding location, the route Kusr is displayed such that the route Kusr passes through or avoids the stairs STR, the escalator ESC, and the elevator ELV.

If there is no response from the user even after lapse of a predetermined time period from the transmission of the boarding location options to the user terminal 20, the vehicle-travel commanding unit 53 selects a boarding location from the boarding location options in accordance with a prescribed criterion, and transmits a travel command to the vehicle 10. In this case, the vehicle-route searching unit transmits a route to the boarding location selected in accordance with the prescribed criterion.

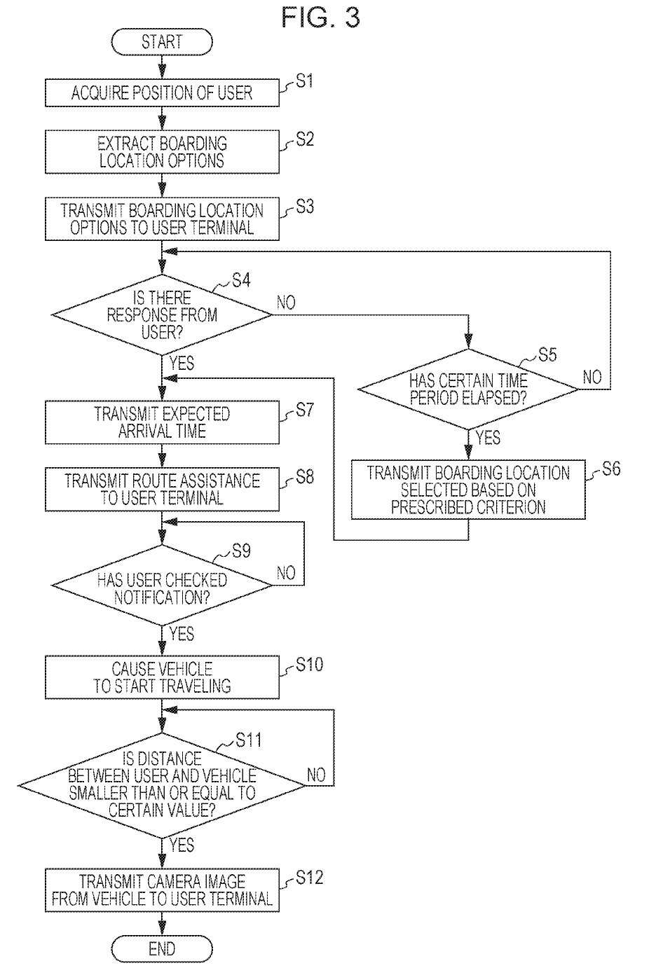

Next, a procedure of a vehicle calling process in the above vehicle calling system 1 will be described with reference to a flowchart illustrated in FIG. 3.

The flowchart in FIG. 3 illustrates a process executed by the central controller 51 when a call signal for the vehicle 10 is received from the user terminal 20 via the communication device 60. This process includes step S1 involving authenticating the user terminal 20 by referring to the user database 70b so as to identify the user and the user's vehicle 10, and acquiring the position of the user in the service area.

In step S2, boarding location options convenient for the user are extracted from the plurality of boarding locations in the service area. In this example, as described above, a maximum of four boarding location options are extracted by evaluating the walking distance, time, level of ease, and vehicle energy consumption.

After the boarding location options are extracted in step S2, the process proceeds to step S3 where the boarding location options are transmitted to the user terminal 20 via the communication device 60, and then to step S4 where it is checked whether there is a response from the user. Since it normally takes a predetermined amount of time for the user to select a boarding location from the options, the process proceeds from step S4 to step S5 where it is checked whether a predetermined time period (e.g., 30 to 60 seconds) has elapsed. If the predetermined time period has not elapsed, the process returns to step S4 to wait for a response.

Subsequently, if a boarding location selected and designated by the user is received from the user terminal 20, the process proceeds from step S4 to step S7. In contrast, if there is no response from the user even after the lapse of the predetermined time period, the process proceeds from step S5 to step S6 where a boarding location is automatically selected in accordance with the prescribed criterion. Then, the process proceeds to step S7. For instance, if there is no response about the selection of a boarding location from the user even after the lapse of the predetermined time period, a location where the user can most quickly board the vehicle 10 is set as a system selection criterion. This selection criterion can be initially set in advance by the user. If there is no initial setting, the system setting is applied.

In step S7, an expected time at which the vehicle 10 is expected to arrive at the boarding location selected and designated by the user is calculated and is transmitted to the user terminal 20 via the communication device 60. The expected arrival time for the vehicle 10 at the designated boarding location is calculated based on the travel distance and the traffic condition from the parking position of the vehicle 10 to the designated boarding location.

Then, the process proceeds to step S8 involving searching through the map database 70a for a route used for traveling to the designated boarding location, transmitting routing assistance toward the designated boarding location to the user terminal 20 via the communication device 60, and simultaneously providing a notification indicating that the vehicle will start moving. Subsequently, the process proceeds to step S9 involving waiting for a response from the user about whether the user has checked the notification indicating that the vehicle will start moving. When the notification is checked, the process proceeds to step S10 where a travel command is transmitted so as to cause the vehicle 10 to travel autonomously from the parking area to the designated boarding location along the route.

The traveling of the vehicle 10 is canceled when the user transmits a cancellation notification from the user terminal 20. A cancellation notification from the user is received as a high-priority interruption process in any step of the process, and the vehicle 10 having exited the parking area is guided to return to the parking area.

Subsequently, in step S11, it is checked whether the distance between the user and the vehicle 10 has become a predetermined value or smaller while tracking the positions of the user and the vehicle 10. When the distance between the user and the vehicle 10 has become the predetermined value or smaller, the process proceeds to step S12 where the vehicle 10 is commanded to transmit an image of the surrounding region of the boarding location captured by the camera to the user terminal 20. Then, the process ends.

The image transmitted to the user terminal 20 in step S12 is not limited to the image captured by the camera in the vehicle 10, and may alternatively be an image obtained by combining a map image of the surrounding region of the boarding location obtained from the map database 70a with a captured camera image of the actual condition. Furthermore, the distance between the user and the vehicle 10 may alternatively be the distance between the vehicle 10 and the boarding location.

Accordingly, in this example, when a user is to board a vehicle by calling the vehicle from a parking area, a parking-area management system extracts boarding location options convenient for the user from a plurality of boarding locations and presents the boarding location options to the user, so that the user can select a desired boarding location from the plurality of boarding locations, thereby achieving a user-friendly system.

Because the boarding location options are extracted based on the parking-position information of the vehicle, the map information of neighboring facilities, and the positional information of the user, and include any of a boarding location with a short walking distance for the user, a boarding location that allows quick boarding for the user, a boarding location that is easily reachable by the user, and a boarding location that is reachable with low energy consumption by the vehicle, the user can select a boarding location in view of the use of stairs, elevators, and escalators, the walk time, and the economic efficiency, thereby achieving an improved service for the user.

Furthermore, since the travel route to the boarding location selected by the user from the boarding location options is transmitted to the user terminal, smooth travel to the boarding location is possible even if the location is visited for the first time. In addition, when the distance between the vehicle and the user becomes a predetermined value or smaller, information about the surrounding region of the boarding location is transmitted to the user terminal, so that the user can easily ascertain the boarding location even if the boarding location is crowded.

1. A vehicle calling system comprising:
a vehicle capable of travelling autonomously from a parking area to a boarding location;
a user terminal configured to transmit a call for the vehicle by being operated by a user; and
a parking-area management system configured to receive the call for the vehicle from the user terminal and to cause the vehicle to travel from the parking area,
wherein the parking-area management system comprises
a boarding-location-option extracting unit configured to extract boarding location options convenient for the user from a plurality of the boarding locations and to transmit the boarding location options to the user terminal in response to the call for the vehicle from the user terminal, and
a vehicle-travel commanding unit configured such that, when a designated boarding location selected and designated by the user from the boarding location options is received from the user terminal, the vehicle-travel commanding unit transmits a command to the vehicle to cause the vehicle to travel to the designated boarding location.

2. The vehicle calling system according to claim 1, further comprising:
a vehicle-route searching unit configured to search for a route along which the user travels toward the designated boarding location and to transmit the route to the user terminal.

3. The vehicle calling system according to claim 1,
wherein the boarding-location-option extracting unit is extracts the boarding location options on a basis of parking-position information of the vehicle, map information of a neighboring facility, and positional information of the user.

4. The vehicle calling system according to claim 2,
wherein the boarding-location-option extracting unit is extracts the boarding location options on a basis of parking-position information of the vehicle, map information of a neighboring facility, and positional information of the user.

5. The vehicle calling system according to claim 1,
wherein the boarding location options include any of a boarding location with a short walking distance for the user, a boarding location that allows quick boarding for the user, a boarding location that is easily reachable by the user, and a boarding location that is reachable with low energy consumption by the vehicle.

6. The vehicle calling system according to claim 2,
wherein the boarding location options include any of a boarding location with a short walking distance for the user, a boarding location that allows quick boarding for the user, a boarding location that is easily reachable by the user, and a boarding location that is reachable with low energy consumption by the vehicle.

7. The vehicle calling system according to claim 5,
wherein the boarding location with the short walking distance for the user is a boarding location that permits use of stairs and that is reachable with a shortest distance.

8. The vehicle calling system according to claim 6,
wherein the boarding location with the short walking distance for the user is a boarding location that permits use of stairs and that is reachable with a shortest distance.

9. The vehicle calling system according to claim 5,
wherein the boarding location that allows quick boarding for the user is a boarding location with an earliest boardable time, the boardable time being a later one of an expected arrival time for the vehicle at the boarding location and an expected arrival time for the user at the boarding location.

10. The vehicle calling system according to claim 6,
wherein the boarding location that allows quick boarding for the user is a boarding location with an earliest boardable time, the boardable time being a later one of an expected arrival time for the vehicle at the boarding location and an expected arrival time for the user at the boarding location.

11. The vehicle calling system according to claim 5,
wherein the boarding location that is easily reachable by the user is a boarding location reachable using a route with a shortest walking distance while excluding use of stairs and prioritizing use of an elevator and an escalator.

12. The vehicle calling system according to claim 6,
wherein the boarding location that is easily reachable by the user is a boarding location reachable using a route with a shortest walking distance while excluding use of stairs and prioritizing use of an elevator and an escalator.

13. The vehicle calling system according to claim 1,
wherein the vehicle-travel commanding unit transmits a command to the vehicle to cause the vehicle to travel to the designated boarding location, and also to transmits, to the user terminal, an expected arrival time for the vehicle at the designated boarding location.

14. The vehicle calling system according to claim 2,
wherein the vehicle-travel commanding unit transmits a command to the vehicle to cause the vehicle to travel to the designated boarding location, and also to transmits, to the user terminal, an expected arrival time for the vehicle at the designated boarding location.

15. The vehicle calling system according to claim 1,
wherein, when a distance between the vehicle and the user becomes a predetermined value or smaller, information about a surrounding region of the designated boarding location is transmitted to the user terminal.

16. The vehicle calling system according to claim 2,
wherein, when a distance between the vehicle and the user becomes a predetermined value or smaller, information about a surrounding region of the designated boarding location is transmitted to the user terminal.

17. The vehicle calling system according to claim 15,
wherein the information about the surrounding region of the designated boarding location comprises image information captured by a camera installed in the vehicle.

18. The vehicle calling system according to claim 16,
wherein the information about the surrounding region of the designated boarding location comprises image information captured by a camera installed in the vehicle.
